(19) United States
(12) Patent Application Publication
(10) Pub. No.: US 2021/0018351 A1
(43) Pub. Date: Jan. 21, 2021

(54) SENSOR SYSTEM

(71) Applicant: Robert Bosch GmbH, Stuttgart (DE)

(72) Inventors: Hermann Heubach, Weinstadt (DE); Michael Keller, Stuttgart (DE)

(21) Appl. No.: 16/981,532

(22) PCT Filed: Jan. 17, 2019
(86) PCT No.: PCT/EP2019/051190

§ 371 Date: Sep. 16, 2020

(30) Foreign Application Priority Data
Mar. 22, 2018 (DE) 10 2018 204 415.5

(51) Int. Cl. G01F 1/684; F02M 35/10

(52) U.S. Cl. CPC G01F 1/684; F02M 35/10386

(57) ABSTRACT

A sensor system for determining the intake air mass of an internal combustion engine. The sensor system includes a grating situated upstream from a plug-in sensor in a main flow direction. The grating is formed annular-shaped around a center axis of a flow tube extending in the direction of the main flow direction. The grating includes grating rings and grating struts extending radially with respect to the center axis and the grating rings. The grating rings and grating struts form passages between them for the intake air flowing in the main flow direction. The grating rings are situated around the center axis and coaxially to one another and are separated from one another by the grating struts.

### BACKGROUND INFORMATION

Greatly varying sensor systems for determining the intake air mass of an internal combustion engine are available in the related art. Many of these sensor systems include a plug-in sensor, which is situated in a flow tube, including a sensor.

The present invention is described hereinafter in particular with reference to a hot-film airflow sensor as a sensor element, as are described, for example, in Konrad Reif (editor): Sensoren im Kraftfahrzeug [sensors in motor vehicles], first edition 2010, pages 146-148, without being restricted thereto. Such hot-film airflow sensors are generally based on a sensor chip, in particular a silicon sensor chip, including a measuring surface over which the flowing fluid medium may flow. The sensor chip includes a heating element and at least two temperature sensors, which are situated on the measuring surface of the sensor chip, for example. A mass flow and/or a volume flow of the fluid medium may be deduced from an asymmetry of the temperature profile detected by the temperature sensors, which is influenced by the flow of the fluid medium. Hot-film airflow sensors are typically designed as plug-in sensors, which are introducible permanently or replaceably in the flow tube. For example, this flow tube may be an intake tract of an internal combustion engine. The plug-in sensor may include a bypass channel structure including an inlet and an outlet, in which the sensor element is situated, for example, in a measuring channel.

To generate a largely anti-interference air mass signal, a preferably uniform airflow to the plug-in sensor is advantageous, so that the intake air flows uniformly through the bypass channel and therein over the measuring surface of the sensor element. The flow tube is typically located at an air filter outlet in internal combustion engines. The outlet of the air filter is connected to the inlet of the flow tube. When there is flow through the intake tract in the main flow direction, strong flow deflections frequently occur. In particular in the area of the entry into the flow tube, areas having a low flow speed exist in the vicinity of the flow tube wall. The flow lines are accordingly deflected and do not extend in parallel to its axis in the vicinity of the flow tube wall. In the areas close to the wall, there may be areas having a low flow speed or flow separation areas and backflow areas. Such changes of the speed field act up to the core area of the flow and may arise quite suddenly in particular in the case of different air mass flows. Moreover, flow separations result in temporally variable speed fields. Due to the changes of the flow field in the vicinity of the inlet and the outlet of the plug-in sensor, worse reproducibility of the signal and increased signal noise result. Furthermore, the pressure drop increases due to such flow separations.

Many sensor systems use a grating situated upstream of the plug-in sensor in the main flow direction through the flow tube as a remedy. The grating may be integrated into the flow tube, for example, and is typically located several centimeters upstream from the plug-in sensor or the sensor in the flow. The grating has the object of making the speed profile in the flow tube uniform and removing possibly existing turbulence from the flow.

Such sensor systems including a grating are described, for example, in German Patent Application Nos. DE 10 2008 041 145 A1 and DE 10 2013 200 344 A1. German Patent Application No. DE 10 2012 211 126 A1 describes a grating which is formed annular-shaped around a center axis of the flow tube, the grating including grating rings and grating struts extending radially in relation to the center axis and the grating rings, the grating rings and grating struts forming passages for the intake air flowing in the main flow direction between them, the grating rings being situated around the center axis and coaxially with respect to one another and being separated from one another by the grating struts, the grating including an outer grating edge facing toward the flow tube and an innermost grating ring which is closest to the center axis.

### SUMMARY

In accordance with an example embodiment, a sensor system according to the present invention uses a grating in which each grating ring which is situated closer to the center axis than a grating ring adjacent to this grating ring, which is situated closer to the grating edge, has a lesser grating ring thickness in the radial direction in a sectional plane extending perpendicularly to the center axis through the grating than the adjacent grating ring situated closer to the grating edge.

In spite of the improvements of the flow behavior in the flow tube which have been possible to achieve using the conventional sensor systems by way of the grating types used therein, high-frequency structural oscillations still often occur in the flow, which may disadvantageously influence the measuring behavior of the sensor system.

In the example sensor system according to the present invention, the mentioned special grating geometry ensures that high-frequency structural oscillations are significantly reduced.

Advantageous designs and refinements of the present invention are enabled by the features described herein.

One specific embodiment of the present invention is particularly advantageous, in which in addition to the above-described design of the grating rings, each grating strut has a grating strut thickness viewed in a sectional plane extending perpendicular to the center axis of the flow tube and in a direction perpendicular to the side walls of the particular grating strut, and in which, with the exception of the innermost grating ring, the grating strut thickness of all grating struts which are situated on a side of a grating ring facing toward the center axis is formed to be less in the sectional plane extending perpendicular to the center axis than the grating strut thickness of grating struts which are situated on a side of this grating ring facing away from the center axis.

The special design of the grating rings and grating struts enables, by way of a special distribution of grating ring thicknesses and grating strut thicknesses ascertained in complex experiments, an optimization of the flow profile in the flow tube upstream from the plug-in sensor with extensive elimination of structural oscillations of the flow in the flow tube.

The advantageous effect is also increased if in addition each grating ring has a lesser grating ring thickness on its upstream end than on its downstream end and in particular has a grating ring thickness less by at least 10% than on its downstream end.

It is furthermore advantageous if the grating ring thickness widens uniformly, viewed in the main flow direction.

Advantageously, each grating strut may have a lower grating strut thickness on its upstream end than on its downstream end. In particular, each grating strut may have a grating structure thickness less by at least 10% on its upstream end than on its downstream end. The grating strut thickness may advantageously widen uniformly in the main flow direction.

An exemplary embodiment of the present invention is particularly advantageous in which the grating, except for the innermost grating ring, also includes at least two further grating rings which are situated between the innermost grating ring and the grating edge. In this grating, it is advantageous if the innermost grating ring is connected via, for example, four grating struts to a second grating ring surrounding the innermost grating ring and the second grating ring is connected via, for example, four grating struts to a third grating ring surrounding the second grating ring and the third grating ring is connected via, for example, eight grating struts to the grating edge. The number of grating struts is only represented by way of example here and may also result differently, of course. Furthermore, the resulting number of grating rings may also be greater or less than the three grating rings represented here.

To achieve the desired effect, it is advantageous if the grating extends in the direction of the center axis over a length of 15 to 25 mm into the flow tube to achieve a preferably good guide effect and directional effect of the grating on the intake air.

### BRIEF DESCRIPTION OF THE DRAWINGS

FIG. 1 shows a schematic structure of the sensor system for an exemplary embodiment of the present invention.

FIG. 2 shows a top view of the flow tube from FIG. 1 including the grating.

FIG. 3 shows a partial cross section through the grating along line III-III from FIG. 2,

FIG. 4 shows a change of the grating strut thickness in the main flow direction for the three grating struts from FIG. 2, which have a different distance from the center axis of the grating.

### DETAILED DESCRIPTION OF EXAMPLE EMBODIMENTS

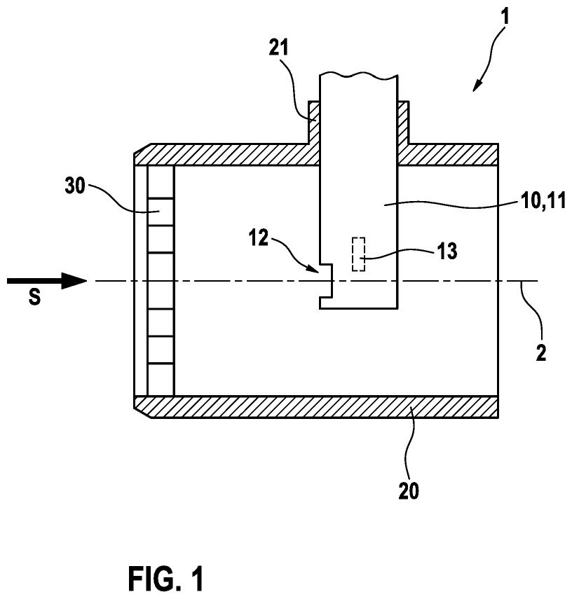

FIG. 1 shows a schematic cross section through a sensor system 1 in accordance with an example embodiment of the present invention. Sensor system 1 includes a flow tube 20, which is designed, for example, as a cylindrical tube or includes, for example, at least one section in the form of a cylindrical tube. Flow tube 20 may be installed as part of an intake air tract in a motor vehicle. Flow tube 20 has a center axis 2, which extends through the center point of the circular cross section of flow tube 20. Flow tube 20 may be made from plastic, for example. Intake air flows in a main flow direction S in flow tube 20. Main flow direction S is defined as the direction in which the intake air flows from one end of the flow tube to the other end of the flow tube in the main axis without local flows or microturbulence formations being observed. In a cylindrical tube, the main flow direction always extends in the direction of the center axis of the cylindrical tube.

Furthermore, flow tube 20 may include a connecting piece 21 on its outer jacket, through which a plug-in sensor 10 is insertable into flow tube 20 in such a way that the inserted part of plug-in sensor 10 protrudes, for example, beyond center axis 2 into flow tube 20. Plug-in sensor 10 includes a housing 11, in which a bypass channel having at least one measuring channel is formed. In FIG. 1, inlet 12 of the bypass channel is recognizable, which is situated, for example, on center axis 2 of the flow tube, but may also be situated offset to the center axis. The outlet is not shown. A sensor element 13 is situated in the measuring channel, which is, for example, a sensor chip of a hot-film airflow sensor. This may be contacted with an evaluation circuit also situated in housing 11. Outside flow tube 20, plug-in sensor 10 may include an electrical plug-in terminal for the wiring harness, for example, of an engine control unit of the motor vehicle.

As may be seen in FIG. 1, a grating 30 is situated upstream from plug-in sensor 10 with respect to main flow direction S of intake air into flow tube 20. Grating 30 may be made up of plastic, for example. Grating 30 may be formed in one piece with flow tube 20, for example, or may be manufactured as a separate part which is installed later in flow tube 20.

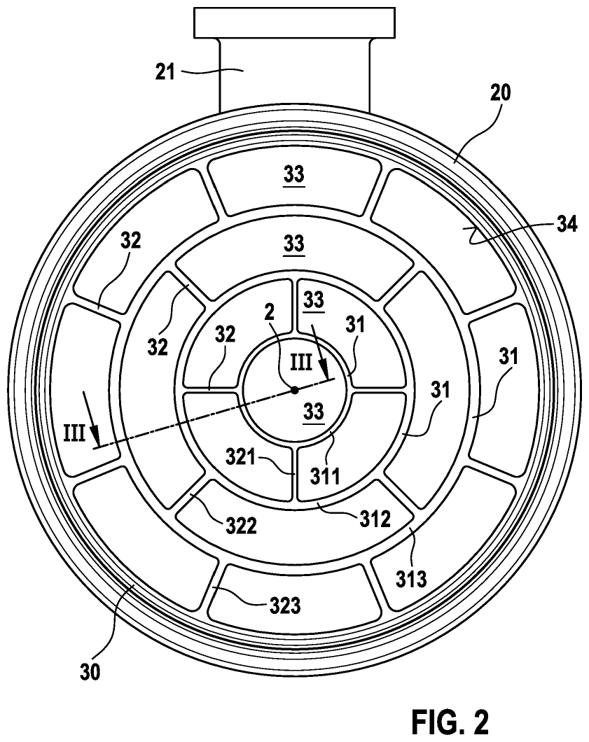

FIG. 2 shows a top view of flow tube 20 from FIG. 1 and an exemplary embodiment of the structure of grating 30. As is shown in FIG. 2, grating 30 is formed annular-shaped around center axis 2 of flow tube 20 extending in the direction of main flow direction S. Center axis 2 extends perpendicularly to the plane of the drawing of FIG. 2. Grating 30 includes grating rings 31 and grating struts 32 extending radially to center axis 2 and grating rings 31. A radial direction is understood as any direction perpendicular to center axis 2. The radial direction points outward toward grating edge 34 starting from the center axis of grating 30. Grating rings 31 and grating struts 32 form passages 33 between them for the intake air flowing in main flow direction S. As is shown in FIG. 2, all grating rings 31 are situated around center axis 2 and coaxially with respect to one another, i.e., their center points are all located in the center axis. Grating rings 31 are separated from one another by grating struts 32. Grating 30 has an outer grating edge 34 facing toward flow tube 20 and an innermost grating ring 311, which is closest to center axis 2.

In the exemplary embodiment shown here, innermost grating ring 311 is connected, for example, via four grating struts 321 to a second grating ring 312 surrounding innermost grating ring 311. Second grating ring 312 is connected, for example, via four grating struts 322 to a third grating ring 313 surrounding second grating ring 312. Third grating ring 313 is connected, for example, via eight grating struts 323 to grating edge 34.

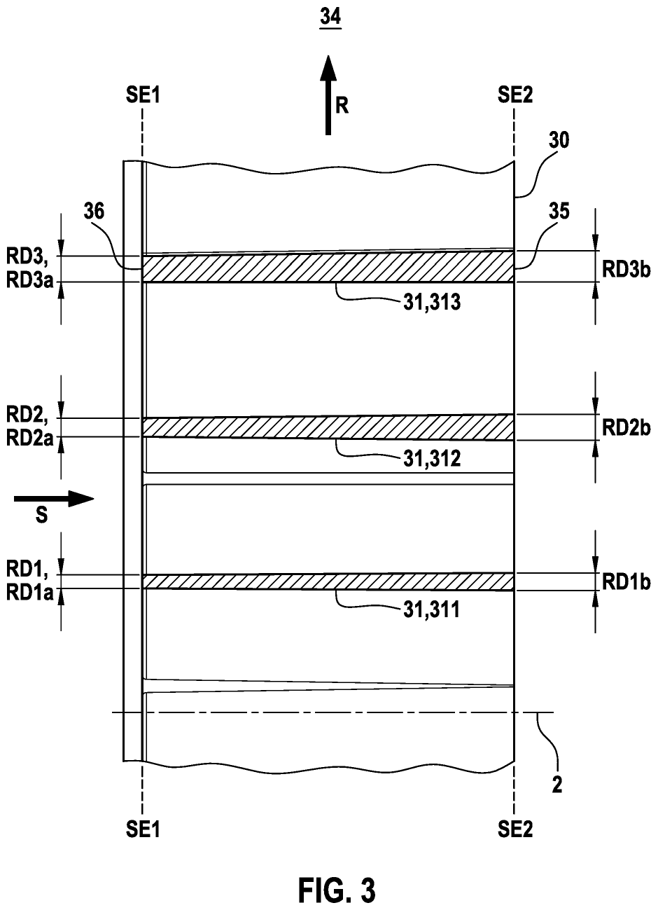

FIG. 3 shows a partial cross section through grating 30 from FIG. 2 along line III-III. A sectional plane SE1 parallel to the plane of illustration of FIG. 2 through the upstream part of grating 30 is shown by dashed lines in FIG. 3. Sectional plane SE1 is thus perpendicular to the plane of the illustration of FIG. 3.

As is shown in FIG. 3, grating rings 31 have a grating ring thickness, which is identified by RD1, RD2, RD3, extending in the radial direction in sectional plane SE1, which extends perpendicularly to center axis 2 through grating 30. The radial direction always extending perpendicular to center axis 2 toward grating edge 34 is identified in FIG. 3 by arrow R. As is shown, grating ring 311 has grating ring thickness RD1 in radial direction R, grating ring 312 has grating ring thickness RD2, and grating ring 313 has grating ring thickness RD3.

As is furthermore shown, it may additionally be provided that each grating ring 31 has a lesser grating ring thickness RD1, RD2, RD3 on its upstream end 36 than on its downstream end 35. However, this is not obligatory and grating ring thicknesses RD1, RD2, and RD3 may also be constant in main flow direction S. In the illustrated preferred exemplary embodiment, grating ring 311 has grating ring thickness RD1a on its upstream end in sectional plane SE1, grating ring 312 has grating ring thickness RD2a, and grating ring 313 has grating ring thickness RD3a. At the downstream end of main flow direction S in the sectional plane SE2 parallel to sectional plane SE1, grating ring 311 has grating ring thickness RD1b, grating ring 312 has grating ring thickness RD2b, and grating ring 313 has grating ring thickness RD3b. The grating ring thickness of a grating ring 31 may also be dependent in the illustrated embodiment on the distance of the observed sectional plane from upstream end 36 of the grating rings. The following applies for each illustrated grating ring: RD1a is less than RD1b, RD2a is less than RD2b, and RD3a is less than RD3b. As illustrated, grating ring thicknesses RD1, RD2, RD3 may widen uniformly, viewed in main flow direction S. It may be possible that the surfaces of grating rings 31 parallel to main flow direction S are inclined by a small angle so that a linear increase of grating ring thicknesses RD1, RD2, RD3 results in main flow direction S. At the upstream and downstream ends of grating rings 31, they may be provided at the edges with small curvature radii (not shown).

The special design of the different grating ring thicknesses of various grating rings described hereinafter is important. Thus, in any arbitrary sectional plane extending perpendicularly to center axis 2 through grating 30, for example, in sectional plane SE1, in radial direction R, the grating ring thickness of a grating ring 31 which is situated closer to center axis 2 is less than the grating ring thickness of an adjacent grating ring 31, which is situated closer to grating edge 34. This thus means: RD1a is less than RD2a and RD2a is less than RD3a. The following also applies in sectional plane SE2: RD1b is less than RD2b and RD2b is less than RD3b. It is shown in FIG. 3 that this relationship also applies to any arbitrary sectional plane between SE1 and SE2. In other words: In any arbitrary sectional plane extending perpendicularly to center axis 2 through grating 30, in radial direction R, the grating ring thickness of a grating ring 31 situated closer to center axis 2 is less than the grating ring thickness of a grating ring 31 situated closer to grating edge 34.

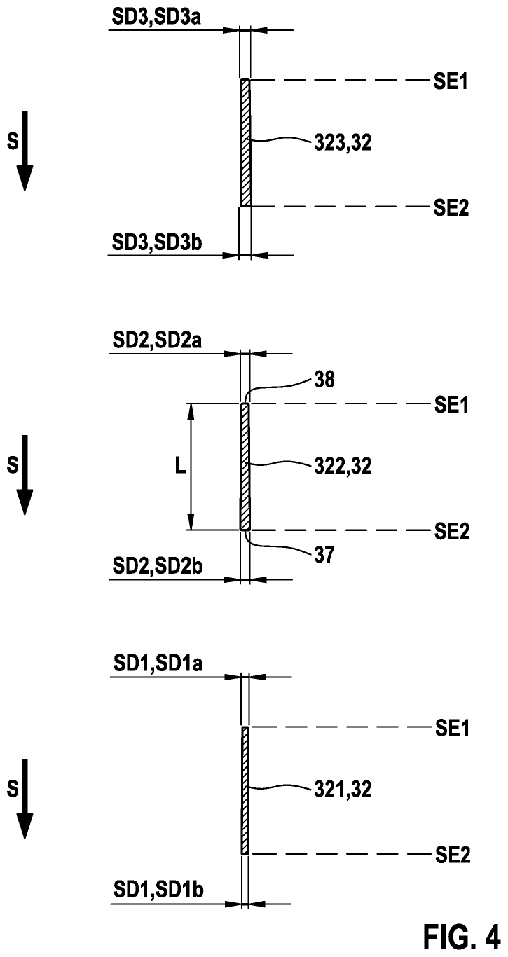

Furthermore, it is advantageous but not absolutely required if the grating struts also have a specific thickness distribution. Each grating strut 32 has, viewed in a sectional plane SE1; SE2 extending perpendicularly to center axis 2 and in a direction perpendicular to the side walls of particular grating strut 32, a grating strut thickness SD1, SD2, SD3. Grating strut thicknesses SD1, SD2, SD3 of grating struts 321, 322, and 323 are shown in FIG. 4.

The sections shown in FIG. 4 through grating struts 32 are cross sections of three grating struts 32 in three different sagittal planes which extend in parallel to center axis 2. Each of the three sagittal planes extends both perpendicularly to the plane of illustration of FIG. 2 and also perpendicularly to the plane of illustration of FIG. 3 through one of grating struts 321, 322, and 323 in each case.

As is shown in FIG. 4, with the exception of innermost grating ring 311 (which does not have any grating struts on the inner side), grating strut thickness SD1, SD2, SD3 of all grating struts 32 which are situated on a side of a grating ring 31 facing toward center axis 2 is formed to be less in each sectional plane SE1; SE2 extending perpendicularly to center axis 2 than grating strut thickness SD1, SD2, SD3 of grating struts 31 which are situated on a side of this grating ring 31 facing away from center axis 2. This is shown in FIG. 2. Thus, if one observes grating ring 312, grating struts 321 having a lesser grating strut thickness SD1 are thus situated thereon on its side facing toward center axis 2, while grating struts 322 having a greater grating strut thickness SD2 in relation thereto are arranged on the side of this grating ring 312 facing away from center axis 2. Thus, SD1 is greater than SD2 and SD2 is greater than SD3.

It may optionally additionally be provided that grating struts 32 have a lesser grating strut thickness SD1, SD2, SD3 on their upstream end 38 than on their downstream end 37. Grating strut thickness SD1, SD2, SD3 may widen uniformly viewed in main flow direction S.

If one observes, for example, upstream sectional plane SE1 of FIG. 3, grating struts 321 in FIG. 4 on the inner side of grating ring 312 thus have grating strut thickness SDla in sectional plane SE1, while grating struts 322 on the outer side of grating ring 312 have grating strut thickness SD2a in sectional plane SE1. Outer grating struts 323, which connect grating ring 313 to grating edge 34, have grating strut thickness SD3a in sectional plane SE1. If one considers downstream sectional plane SE2 of FIG. 3, grating struts 321 in FIG. 4 on the inner side of grating ring 312 thus have grating strut thickness SD1b in sectional plane SE2, while grating struts 322 on the outer side of grating ring 312 have grating strut thickness SD2b in sectional plane SE2. Outer grating struts 323, which connect grating ring 313 to grating edge 34, have grating strut thickness SD3b in sectional plane SE2. As is shown in FIG. 4: SDla is less than SD1b, SD2a is less than SD2b, and SD3a is less than SD3b.

The grating preferably extends in the direction of center axis 2 over a length L of 15 to 25 mm, in particular a length L of 20 mm in flow tube 20.

In one preferred exemplary embodiment, flow tube 20 has an internal diameter of, for example, 63.7 mm. The grating ring thicknesses of the three grating rings 311, 312, 313 are preferably designed as follows in upstream sectional plane SE1 and downstream sectional plane SE2: RD1a=0.7 mm; RD1b=1 mm; RD2a=1.0 mm; RD2b=1.3 mm; RD3a=1.3 mm, and RD3b=1.6 mm. The grating strut thickness of grating struts 321, 322, and 323 preferably designed as follows in upstream sectional plane SE1 and downstream sectional plane SE2: SD1a=0.85 mm; SD1b=1.15 mm; SD2a=1.15 mm; SD2b=1.45 mm; SD3a=1.3 mm, and SD3b=1.6 mm.

1-9. (canceled)

10. A sensor system for determining the intake air mass of an internal combustion engine, the sensor system comprising:
a plug-in sensor, situated in a flow tube, having a sensor element configured to determine intake air flowing in the flow tube in a main flow direction; and
at least one grating situated upstream from the plug-in sensor in the main flow direction, the grating being formed annular-shaped around a center axis of the flow tube which extend in a direction of the main flow direction, the grating including grating rings, and grating struts extending radially with respect to the center axis and the grating rings, the grating rings and grating struts forming passages between them for the intake air flowing in the main flow direction, the grating rings being situated around the center axis and coaxially to one another and being separated from one another by the grating struts, the grating including an outer grating edge facing toward the flow tube, and an innermost grating ring, which is closest to the center axis, wherein each grating ring of the grating rings, which is situated closer to the center axis than an adjacent grating ring adjacent to the grating ring, which is situated closer to the grating edge, has a lesser grating ring thickness in a radial direction in a sectional plane extending perpendicularly to the center axis through the grating than the adjacent grating ring situated closer to the grating edge.

11. The sensor system as recited in claim 10, wherein each grating strut of the grating struts has a grating strut thickness in the sectional plane extending perpendicularly to the center axis and viewed in a direction perpendicular to side walls of the grating strut, and with the exception of the innermost grating ring, the grating strut thickness of all grating struts, which are situated on a side of a grating ring facing toward the center axis is less in the sectional plane extending perpendicular to the center axis than the grating strut thickness of grating struts, which are situated on a side of the grating ring facing away from the center axis.

12. The sensor system as recited in claim 10, wherein each of the grating rings has a lesser grating ring thickness on its upstream end than on its downstream end.

13. The sensor system as recited in claim 12, wherein the grating ring thickness widens uniformly viewed in the main flow direction.

14. The sensor system as recited in claim 10, wherein each of the grating struts has a lesser grating strut thickness on its upstream end than on its downstream end.

15. The sensor system as recited in claim 14, wherein the grating strut thickness widens uniformly, viewed in the main flow direction.

16. The sensor system as recited in claim 10, wherein the grating also includes, in addition to the innermost grating ring, at least two grating rings which are situated between the innermost grating ring and the grating edge.

17. The sensor system as recited in claim 10, wherein the innermost grating ring is connected via four grating struts to a second grating ring surrounding the innermost grating ring, and the second grating ring is connected via four grating struts to a third grating ring surrounding the second grating ring, and the third grating ring is connected via eight grating struts to the grating edge.

18. The sensor system as recited in claim 10, wherein the grating extends in the direction of the center axis over a length of 15 to 25 mm into the flow tube.
